(19) United States
(12) Patent Application Publication
(10) Pub. No.: US 2001/0043308 A1
(43) Pub. Date: Nov. 22, 2001

(54) Cover apparatus for eyeglass temple arms

(76) Inventors: Nicole E. Menuck, Sylvan Lake, MI (US); Bonnie E. Glasier, Bloomfield Hills, MI (US)

Correspondence Address: Ernest I. Gifford, Gifford, Krass, Groh, Sprinkle, Anderson & Citkowski, P.C., 280 N. Old Woodward Avenue, Suite 400, Birmingham, MI, 48009-5394, US

(21) Appl. No.: 09/851,707

(22) Filed: May 9, 2001

Related U.S. Application Data
(60) Provisional application No. 60/202,556, filed on May 10, 2000.

(51) Int. Cl. G02C 5/14; G02C 5/18

(52) U.S. Cl. 351/111; 351/117

(57) ABSTRACT

A cover for each of the temple arms of a pair of eyeglasses to protect the temple arms from chemical contamination during the treatment and dying of hair. The covers fit loosely on the temple arms for easy installation and removal after use and are made of flexible economical material permitting disposal.

This application claims the benefit of Provisional Patent Application Serial No. 60/202,556 filed May 10, 2000.

### FIELD OF THE INVENTION

The present invention relates generally to a cover for eyeglasses. More particularly, the present invention concerns a cover for eyeglass temple arms to protect the arms from corrosion.

### BACKGROUND OF THE INVENTION

Eyeglasses are a necessary part of the life for millions of individuals around the world. Eyeglasses are manufactured in a vast array of style, but have typically been constructed from plastic or metal coated at least in part with a plastic. However, problems often arise when plastic eyeglasses (or the plastic portions of eyeglass, e.g., the earpiece) encounter corrosive chemical materials.

One environment that readily lends itself to contact between eyeglasses and corrosive chemicals is a modern hair salon or studio. Hair treatments and dyes used in the coloring of hair will often come into prolonged contact with a persons eyeglasses during the hours long process of cutting, treatment, dying and styling of hair. For example, during their time at the salon, a customer that wears eyeglasses may choose to read a magazine or watch TV. Each of these activities requires the customer to wear their eyeglasses. Therefore, during a typically salon visit, the eyeglasses, particularly the temple arm earpiece, will come into direct contact with a variety of hair treatments and dyes that will corrode or otherwise discolor the eyeglasses. Therefore, it would be advantageous for the eyeglass wearer to have a removable, disposable cover that may be worn over the eyeglasses to inhibit or prohibit contact of the eyeglasses with the hair treatment chemicals.

It is important also that the cover be easily and rapidly installed and even more importantly, that the cover be easily removed after it has served its purpose without contamination of the eyeglasses from the chemicals that may adhere to the cover.

Prior art structures have made an effort to cover the temple arms of eyeglass for the purpose of comfort and also for protecting the eyeglasses themselves. Unfortunately, such devices have been complex and costly and typically have used means to secure the covers firmly in position on the eyeglass frames which adds not only to the cost of manufacture but also complicates the installation and removal of the covers after they have been used and possibly contaminated.

### BRIEF DESCRIPTION OF THE DRAWINGS

A clearer understanding of the present invention will be had upon reference to the several views wherein like reference numerals refer to like parts and wherein:

FIG. 1 is a perspective view of the preferred embodiment of the present invention; and

FIG. 2 is a perspective view of an alternate embodiment of the present invention.

### DETAILED DESCRIPTION OF THE INVENTION

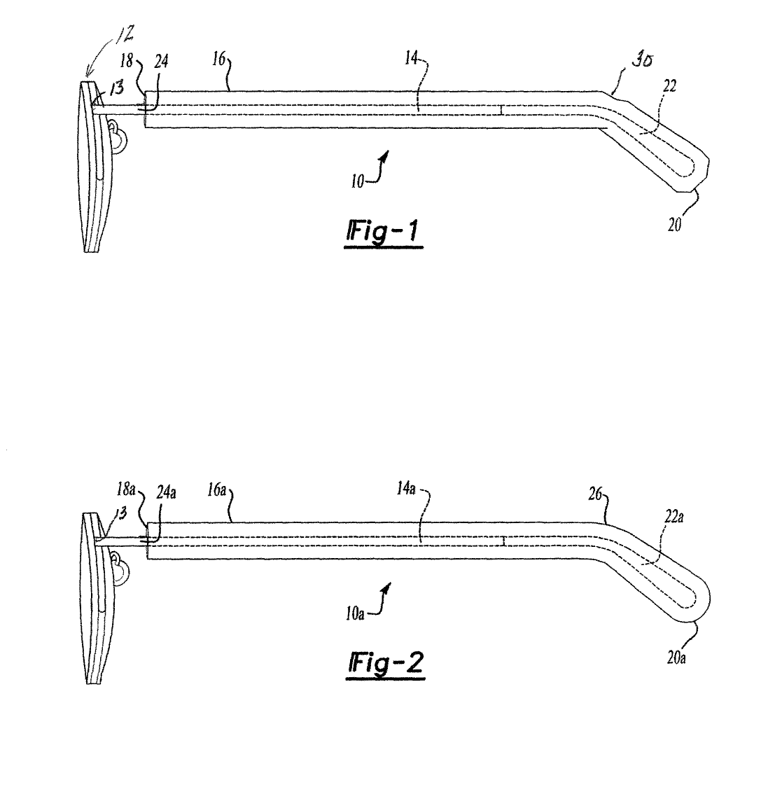

As seen in FIG. 1 an apparatus of the present invention comprises a cover 10 for placement over and around each one of the temple arms 14 hinged to an eyeglass or lens frame 12 at points designated at 13.

The cover 10 preferably comprises an elongated, tubular body 16 having an open end 18 and a closed end 20. The body 16 and open end 18 are dimensioned to fit around a wide variety of temple arms 14. Preferably, the diameter of the open end 18 of the body 16 is between 4 to 20 mm. when in tubular shape. Since the material forming the body 16 is flexible and may be of different cross-sectional configurations the perimeter or girth of the tubular cross-section is substantially uniform and between 12 mm. and 60 mm. or slightly larger than the largest girth of the temple arm 14 it is to cover. The length of the body 12 must also be sufficient to extend along the entire temple arm 14 from the earpiece 22 to the hinged end at 13. A preferred length of the body 16 is between 10 to 16 cm. However, the body 16 may be longer or shorter and if necessary can be cut to conform to the length of the temple arm 14. The cover 10 preferably is constructed of plastic or similar material. It also could be constructed of paper, such as crepe or wax-coated paper and like material. Alternatively, the cover 10 may be constructed of any elastic, flexible and lightweight material. The cover 10 may be disposable, but may be reusable by using materials that are more durable.

Shown in FIG. 2, is an alternate embodiment of the cover 10a of the present invention. The cover of the alternate embodiment includes a body 16a having an open end 18a and sealed end 20a. The body 16a further comprises a bend portion 26. Preferably, the bend 26 is positioned in spaced relation relative to a butt strap 24a at the opposite or hinge end 13 of the temple arm 14a. The bend 26 of the body 16a allows the cover to conform to the shape of the bent temple arm 14a and offers resistance to longitudinal displacement of the cover on the temple arm 14a.

In operation, a person wearing the eyeglasses removes their glasses and places the cover over the temple arms by inserting the end pieces 20, 20a in the open ends 18, 18a of the cover 10, 10a and sliding the temple arms and end pieces towards the closed end 20, 20a of the cover. The cover 10 fits loosely on the temple arms but the motion of placing the eyeglasses on the head brings the covers 10 into contact with opposite sides of the head of a user to urge the covers 10 forwardly on the temple arms 14 toward lens frame 12 to maintain the end pieces 22, 22a in position relative to closed end 20, 20a, respectively. Once in position on the head of the wearer, the wall of the cover 10 is trapped between the temple arm 14 and the wearer's head to maintain the cover's 10 in position on the temple arm 14.

In the embodiment shown in FIG. 1 the cover 16 is folded or distorted slightly at the bend 30 between the temple arm 14 and earpiece 22 which also serves to resist longitudinal displacement of the cover 10 on the temple arm 14. Similarly, the bend 26 in the alternative embodiment in FIG. 2 acts to reset displacement of the cover body 20. The cover protects the temple arm from direct contact with hair treatments, dyes and other corrosive chemicals throughout the salon visit. Upon completion of the salon visit, the user removes the eyeglasses and the covers from the temple arms after which the contaminated covers can be disposed of or cleaned for reuse.

Having described my invention, other apparatus and embodiments will be apparent to those of skill in the art that do not depart from the scope or claim of the present invention.

I claim:

1. A cover for eyeglass temple arms comprising:
eyeglasses having a pair of temple arms; and
a cover member, said cover member having an elongated body, said body having an open end and a closed end;
whereby the cover member is inserted over the temple arm of the eyeglasses through the open end of the body.

2. The cover of claim 1 wherein said body is made of flexible material.

3. The cover of claim 2 wherein said flexible material is paper.

4. The cover of claim 2 wherein said flexible material is plastic.

5. The cover of claim 1 wherein said temple arms can have a bend to form an earpiece and said body members are formed with a bend complementary to said bend forming said earpiece.

6. A cover for protecting a pair of temple arms hinged to a frame of a pair of eyeglasses from contamination, comprising:
a pair of elongated tubular members, each having an open end and a closed end;
said tubular members having a transverse girth larger than the girth of the largest cross-section of said temple arm members; and
said tubular members being supported on said temple arms and having a length covering the entire length of said temple arms to isolate temple arms from contamination.

7. The combination of claim 6 wherein said elongated tubular member is made of flexible material.

8. The combination of claim 7 wherein said flexible material is paper.

9. The combination of claim 7 wherein said flexible material is plastic.

10. The combination of claim 6 wherein said temple arms each have a bend to form an ear piece, and said tubular member being bent to accommodate said bend in said temple arms.
